(19) United States
(12) Patent Application Publication
(10) Pub. No.: US 2002/0037395 A1
(43) Pub. Date: Mar. 28, 2002

(54) Ink jet recording medium

(76) Inventors: Qiping Zhong, Cupertino, CA (US); Huiyong P. Chen, San Jose, CA (US); Elinor Tanck, Sunnyvale, CA (US); Akio Nishino, San Jose, CA (US); Chul Chai, Mt. Olive, NJ (US)

Correspondence Address: Jeffery B. Arnold, KILPATRICK STOCKTON LLP, Suite 2800, 1100 Peachtree Street, Atlanta, GA, 30309-4530, US

(21) Appl. No.: 09/911,359

(22) Filed: Jul. 23, 2001

Related U.S. Application Data
(60) Provisional application No. 60/219,883, filed on Jul. 21, 2000.

(51) Int. Cl. B32B 3/00

(52) U.S. Cl. 428/195; 428/203; 428/211

(57) ABSTRACT

Disclosed is a printing medium useful for inkjet printing and provides opacity for either with or without back light applications. A printing medium made in accordance with the present invention includes a substrate, a first coating layer disposed on the substrate, and a second coating layer disposed on the first coating layer. The second coating layer has a microporous structure and comprises at least one hydrophobic polymer and at least one liquid absorbing filler dispersed substantially throughout the at least one hydrophobic polymer.

In an other aspect of the present invention, the printing medium has an ink retaining first coating layer and an ink transmissive second coating layer formed of at least one hydrophobic polymer and at least one liquid absorbing filler. The first and second coating layers are respectively disposed on a substrate.

Yet, in another aspect of the present invention, the printing medium has a substrate comprised of an organic transparent or translucent material, a first coating layer upon said substrate, and a second coating layer upon said first coating layer. The first coating layer employs at least one hydrophilic polymer. The second coating layer has a microporous structure formed by the combination of at least one liquid absorbing, inorganic filler incorporated into at least one organic, hydrophobic polymer.

This application claims priority to U.S. Provisional Patent Application Ser. No. 60/219,883 filed Jul. 21, 2000.

### FIELD OF THE INVENTION

This invention relates to a recording medium for ink jet printing. In particular, it relates to a recording medium which may be employed for backlit or reflective light viewing.

### BACKGROUND OF THE INVENTION

Reverse printed films used with back lighting are popular in the marketplace. In particular, such recording media capable of high speed printing and multicolor printing of such films are desired. However, there are disadvantages and limitations for this type of media currently available in the marketplace. First, they have minimal water-resistance, and the media requires careful handling to avoid fingerprints on the media. Second, the print ink drying time is long, especially under high humidity. Third, some inks bleed when applied to the media. These media give unsatisfactory prints with piezo ink application printers. Furthermore, these media generally perform poorly when used with pigmented inks. Finally, most products are not “universal,” but are designed for use on a limited number of printers. Prints on such non-universal media made with unspecified printers generally have low density print quality, ink bleeding, prolonged ink drying time, and/or poor backlit viewing quality. In an attempt to address ink absorbency, both U.S. Pat. Nos. 4,785,313 and 5,059,983 describe a recording medium consisting of a two layer medium supported by a substrate.

When making “photo quality” ink jet images, it has been found that glossy uniformity is affected by ink loading in the specific area printed. For instance, the more ink loading, the less gloss results. This phenomenon is profound when a pigmented ink is used. Examples of such media are described in U.S. Pat. No. 5,264,275 and EP 888,904.

### SUMMARY OF THE INVENTION

The present invention relates to a printing medium that includes a substrate, a first coating layer disposed on the substrate, and a second coating layer disposed on the first coating layer. The second coating layer has a microporous structure and comprises at least one hydrophobic polymer and at least one liquid absorbing filler dispersed substantially throughout the at least one hydrophobic polymer.

In another aspect of the present invention, the printing medium has an ink retaining first coating layer and an ink transmissive second coating layer comprising at least one hydrophobic polymer and at least one liquid absorbing filler. The first and second coating layers are respectively disposed on a substrate.

Yet, in another aspect of the present invention, the printing medium has a substrate comprised of an organic transparent or translucent material, a first coating layer upon said substrate, and a second coating layer upon said first coating layer. The first coating layer is comprised of at least one hydrophilic polymer. The second coating layer is comprised of a microporous structure formed by the combination of at least one liquid absorbing, inorganic filler incorporated into at least one organic, hydrophobic polymer.

According to the present invention, a printing medium made in accordance with the present invention provides a first coating layer that is substantially non-porous and has excellent ink absorption and dye fixing abilities. Further, the second coating layer has a microporous structure which allows inks comprising acid-based dyes, reactive-base dyes, or pigments to penetrate through the second coating layer to the first coating layer. Such printing medium provides substantially virtual instant ink drying capability along with high reflective density, high backlit density, color fidelity, high resolution, minimal ink bleeding, some water resistance, and good handling properties.

### BRIEF DESCRIPTION OF THE DRAWING

FIG. 1 is a cross-section depiction of a printing medium made in accordance with the present invention illustrating a substrate, a first coating layer, and a second coating layer.

### DETAILED DESCRIPTION OF THE INVENTION

The present invention relates to a printing medium that includes a substrate, a first coating layer disposed on the substrate, and a second coating layer disposed on the first coating layer. The second coating layer has a microporous structure and comprises at least one hydrophobic polymer and at least one liquid absorbing filler dispersed substantially throughout the at least one hydrophobic polymer.

In another aspect of the present invention, the printing medium has an ink retaining first coating layer and an ink transmissive second coating layer comprising at least one hydrophobic polymer and at least one liquid absorbing filler. The first and second coating layers are respectively disposed on a substrate.

Yet, in another aspect of the present invention, the printing medium comprises a substrate comprised of an organic transparent or translucent material, a first coating layer upon said substrate, and a second coating layer upon said first coating layer. The first coating layer is comprised of at least one hydrophilic polymer. The second coating layer is comprised of a microporous structure formed by the combination of at least one liquid absorbing, inorganic filler incorporated into at least one organic, hydrophobic polymer.

Substrates

Substrates employed in the present invention may comprise a transparent, translucent, or opaque material, and may be either rigid or flexible. Examples of such substrates include, but are not limited to, substrates comprising a polymer, a paper, a glass, a ceramic, and a woven or non-woven cloth. Polymeric substrates include, but are not limited to, substrates comprising a polymer selected from polyesters, polycarbonates, cellulose esters, polyurethanes, polyester-ethers, polyether-ketones, vinyl polymers, polystyrene, polyethylene terephthalate, polysulfones, polybutylene terephthalate, polypropylene, methacrylates, diallyl phthalates, cellophane, acetates, cellulose diacetate, cellulose triacetate, celluloid, polyvinyl chloride, or combinations thereof. As indicated above, the substrate employed in the present invention includes transparent films formed from polyesters, polycarbonates, and vinyl polymers and polyolefin polymers, such as propylenes, but is not limited to such transparent films. These transparent films can provide a printing medium having a high gloss surface, since the glossiness may be provided by the substrate. In accordance with the present invention, any ink loading in print will not substantially affect the image gloss. When low glare or gloss is desired, a translucent film may be used. Examples of polyester films include SH 81 and SH 91 SKYROL™ polymers available from SKC America Inc., polypropylene film available from Granwell Products Inc., and polycarbonate films from GE Plastics. However, a high or low gloss surface can also be provided to the printing medium by the second coating layer discussed below even if the substrate does not have a respective high or gloss surface.

First Coating Layer

As indicated above, the first coating layer is substantially non-porous and comprises at least one hydrophilic polymer. Accordingly, the first coating layer has the ability to quickly absorb relatively large amounts of ink, commonly employed in backlit printing, and avoid or minimize bleeding of the dye or pigment in the ink. Organic polymers with good water and solvent absorption are employed in the first coating layer. When the printed image is to be view through the substrate, both the substrate and the first coating layer should be either transparent or translucent. Additionally, the first coating layer should comprise a light-transmissive polymer or resin capable of absorbing the ink and/or a light-transmissive polymer or resin having solubility and swelling properties compatible to the ink. The polymers comprising the first coating layer may not be particularly limited if they function to absorb and capture the ink and/or dye or pigment components of the ink and are capable of forming a substantially non-porous layer. Coating compositions of the first coating layer can be applied to the substrate by means of a roller coater, a knife coater, wire wound rod, or any conventional coating method.

The first coating layer comprises at least one hydrophilic polymer, at least one cationic resin, or a combination thereof. Hydrophilic polymers may be natural or synthetic and include, but are not limited to, polyvinyl pyrrolidone, polyvinyl alcohol, acrylic polymers, copolymers which possess hydrophilic groups such as hydroxy or carboxy, cellulose polymers, starch, gelatin, albumin, casein, cation starch, natural resins such as gum arabic and sodium alginate, polyamide, polyacrylamide, polyethylene imine, polyvinyl pyridylium halide, melamine resin, polyurethane, polyester, and sodium polyacrylate, natural or synthetic hydrophobic polymers modified by making these polymers insoluble in water and water absorbing, and the like. Combinations of such polymers may also be employed in the present invention.

Hydrophilic polymers employed in the present invention also include block copolymers or graft copolymers having hydrophilic segments and hydrophobic segments within the molecule, crosslinked water-soluble polymers, and a polymer complex comprising two or more water-soluble or hydrophilic polymers.

Although block copolymers or graft copolymers are generally water-insoluble, such copolymers are hydrophilic. The hydrophilic segments of such polymers are, for example, segments formed by polymerization of two or more vinyl monomers having hydrophilic groups such as a carboxyl group, a sulfonic acid group, a hydroxyl group, an ether group, an acid amide group, methylol groups of these, a primary to tertiary amino group and a quaternary ammonium group. Examples of such hydrophilic monomer may include acrylic or methacrylic acid, maleic anhydride, vinyl sulfonic acid, sulfonated styrene, vinyl acetate, monoacrylates or monomethacrylates or monomaleates of polyols such as ethylene glycol, acrylic or methacrylic amides or methylols of these, mono- or dialkylaminoethyl acrylate or methacrylate, quaternary compounds of these, vinyl pyrrolidone, vinyl pyrimidine, and the like. The hydrophobic polymer segments are polymers of two or more of monomers including olefins such as ethylene, propylene and butylene; aromatic vinyl compounds such as styrene, methylstyrene and vinyl naphthalene; halogenated olefins such as vinyl chloride, vinylidene chloride and vinylidene fluoride; various alcohol esters of unsaturated carboxylic acids such as acrylic or methacrylic acid and crotonic acid; and the like.

Crosslinked water-soluble polymers which may be employed in the present invention. Such polymers are obtained by crosslinking the water-soluble polymers mentioned above by suitable crosslinking agents known in the art or radiation to the degree that that the polymer is made insoluble in water without losing its hydrophilic nature.

A polymer complex which may be employed in the present invention comprises two or more water-soluble or hydrophilic polymers which are different from each other and may act on each other, such as a polymer complex comprising a basic polymer and an acidic polymer. For example, two or more of polymers are strongly bonded through electrostatic force between ions, hydrogen bonding, van der Waals force, partial migration of electrical charge, and the like.

Additionally, commercially available dye fixing agents may be added to the polymers or resins of the first coating layer. Examples of such dye fixing agents include, but are not limited to, organic acids such as sulfonic acids, citric acid, polyacrylic acid, and other acids; aliphatic and aromatic amines; polyimine; polyamine; and the like. Other examples of fixing agents can be found in U.S. Pat. Nos. 5,656,378; 5,723,179; and 5,693,410, all of which are incorporated herein by reference. The percentage of such additives in the first coating layer may range from about 1 wt. % to about 40 wt. % based upon the weight of the hydrophilic polymer. In another aspect of the present invention, such additives may rang from about 5 wt. % to about 20 wt. % based on the weight of the polymeric binder. The coating thickness of the first coating layer may range from about 3 microns to about 25 microns. In another aspect of the present invention, the coating thickness of the first coating layer may range from about 7 microns to about 15 microns.

Second Coating Layer

The second coating layer referred to above has a porous structure and comprises at least one hydrophobic polymer and at least one liquid absorbing filler. As a result, the second coating layer has a relatively large porous volume with good bonding and mechanical strength and allows quick ink penetration through the second coating layer to the first coating layer. Additionally, the composition of the second coating layer provides the capability of high opacity for special applications, such as backlit applications. Coating compositions of the second coating layer can be applied to the first coating layer by means of a roller coater, a knife coater, wire wound rod, or any conventional coating method. In one aspect of the present invention, the second coating layer has a thickness in a range between about 5 microns to about 50 microns. In another aspect of the present invention, the second coating layer has a thickness in a range between about 15 microns to about 35 microns.

Hydrophobic polymers or resins employed in the second coating are typically are insoluble in water, but not required. Such polymers or resins bind the liquid absorbing particles within the second coating layer and bind the second coating layer to the first coating layer. It is not required for the second coating layer to be non-dyable to the ink, but may be non-dyable.

In the present invention, the surface or the inside of the second coating layer has a porous structure containing fissures, communicated holes (including those of micro size), or pores as indicated above. Such a porous structure, for example, may be formed by the liquid absorbing particles which are dispersed substantially throughout the second coating layer. Further, the second coating layer may be made porous or more porous in addition to the pores created by the liquid absorbing fillers by treating the second coating layer with a solvent. Likewise, pores may be created by dissolving the polymer or resin of the second coating layer in a mixed solvent so that a high boiling solvent may act as a poor solvent for the resin to make porous the inside of the second coating layer. Additionally, a foamable material may be disposed in the composition of the second coating layer to form open micro-cells such that the inside of the second coating layer is porous.

Examples of hydrophobic polymers or resins which may be employed in the present invention include, but are not limited to, polyethylene, polypropylene, polyurethanes, vinyl acetate, cellulose esters, cellulose acetate propionate, polyvinyl chloride-vinyl acetate copolymer, poly(alkyl)acrylates, ionomer polymers, acrylonitrile-styrene copolymer, ethylene-vinyl acetate copolymer, vinylidene chloride, polyvinyl acetate, styrene-acrylic copolymer, phenolic resins, isobutylene-moleic anhydride copolymer, epoxy resins, polyvinylidene chloride, xylene-formaldehyde resins, cumarone resins, ketone resins, polyvinyl butyral resins, acrylic resins, starch, methyl cellulose, ethyl cellulose, styrene butadiene rubber, polychloroprene resins, melamine formaldehyde resins, nitrile rubber, urea formaldehyde resins, and the like. Additionally, any combination of such hydrophobic polymers or resins may be employed.

Examples of commercially available polymers which may be employed in the present invention include polyurethanes sold by BF Goodrich under the tradename ESTANE™ cellulose esters such as cellulose acetate propionate sold by Eastman Chemical Company, vinyl acetate polymers such as AYAt sold by Union Carbide, polyvinyl chloride-vinyl acetate copolymers sold by Union Carbide under the tradename UCAR™, and methacrylate resins sold by ICI Acrylics under the tradename ELVACITE™, as well as acrylics and alkyl acrylate homopolymers and interpolymers in general. Mixtures of binders may be used to achieve the desirable bonding properties and the microporous structure. Additionally, the above described polymers and resins useful to reduce dye fixing of the ink in the first coating layer.

The liquid absorbing fillers employed in the present invention are porous and may comprise inorganic particles or polymeric particles. In one aspect of the present invention, the liquid absorbing fillers comprise particles having an average diameter between about 2 nanometers to about 50 microns. In another aspect of the present invention, the liquid absorbing fillers comprise particles having an average diameter between about 2 microns to about 25 microns. Examples of inorganic fillers include but are not limited to silica; siliceous particles such as talc, calcium silicate, aluminum silicate, titanium silicate, and clays; titanium dioxide; alumina; and the like. Combinations of any of such inorganic fillers may be employed in the present invention. Examples of porous polymeric fillers include, but are not limited to, polyethylene, polypropylene, polyurethane, vinyl acetate, cellulose esters, cellulose acetate propionate, polyvinyl chloride-vinyl acetate copolymer, poly(alkyl)acrylates, ionomer polymers, acrylonitrile-styrene copolymer, ethylene-vinyl acetate copolymer, vinylidene chloride, polyvinyl acetate, styrene-acrylic copolymer, phenolic resins, isobutylene-moleic anhydride copolymer, epoxy resins, polyvinylidene chloride, xylene-formaldehyde resins, cumarone resins, ketone resins, polyvinyl alcohol, polyvinyl butyral resins, polyvinyl pyrrolidone, acrylic resins, starch, carboxymethyl cellulose, methyl cellulose, ethyl cellulose, styrene butadiene rubber, gelatin, casein, polychloroprene resins, melamine formaldehyde resins, nitrile rubber, urea formaldehyde resins, and the like. Various methods of making porous polymeric particles are described in German Patent No. 2552613 to Stoy entitled “Production of Spherical Polymer Particles From Polymer Solutions,” Japanese Patent No. 62054735 entitled “Porous Polymer Particles,” Japanese Patent No. 03227323 to Tada et al. entitled “Porous Polymer Emulsions and Particles Obtained From Them,” Japanese Patent No. 02173003 to Nittatsu et al. entitled “Manufacture of Porous Polymer Particles by Suspension Polymerization,” and Cheng, C. M. et al., Pore Structural Studies of Monodisperse Porous Polymer Particles, J. Colloid Interface Sci., 150(2), pp. 549-58 (1992), all of which are incorporated herein by reference. Any combination of such porous polymeric fillers may be employed in the present invention. Further, any combination of inorganic and polymeric fillers may likewise be employed in the present invention. In one aspect of the present invention, the weight ratio of the liquid absorbing filler to the hydrophobic polymer or resin in the formulation of the second coating layer may vary in a range between about 0.3 to about 15. In another aspect of the present invention, the weight ratio of the liquid absorbing filler to the hydrophobic polymer or resin in the formulation of the second coating layer may vary in a range between about 0.6 to about 10. Such variation depends upon the structure of the liquid absorbing fillers, the hydrophobice polymer or resin employed, and the desired absorbency of the second coating layer, all of which may be tailored as desired. Different types or compositions of fillers with a variety of particle sizes and shapes may be combined to achieve desirable properties, such as, opacity and pore volume.

Other additives can be provided to both the first coating layer and the second coating layer conventionally known in the art. Examples of such additives which may be employed in the present invention include, but are not limited to, surfactants, optical brightners, UV-absorbers, stabilizers, and the like.

In an aspect of the present invention, a printing medium made in accordance with the present invention employs a polyester substrate produced by SKC America Inc. under the tradenames SH 81 or SH 91 SKYROL™. The first coating layer comprises a composition as described in Examples 1-4 below. Further, second coating layer comprises a composition as described in Examples 1-4 below.

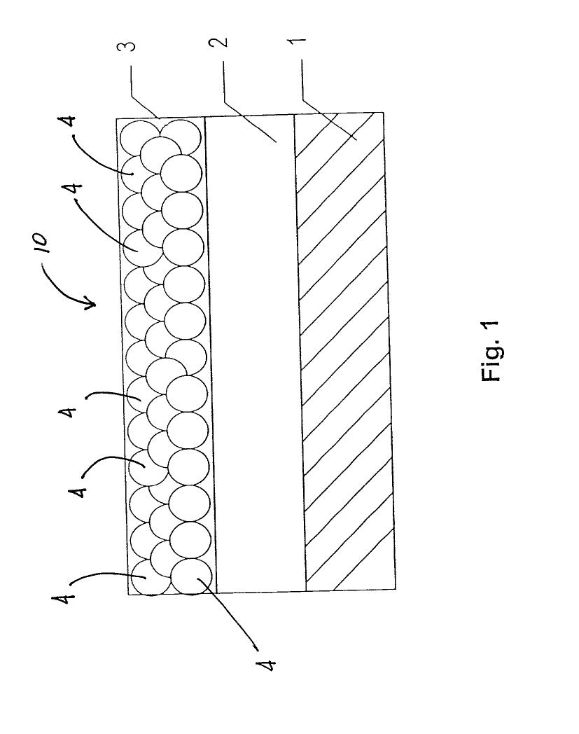

FIG. 1 is a cross-section illustration of a printing medium 10 made in accordance with the present invention. A first coating layer 2 as described above is disposed upon a substrate 1, likewise described above. A second coating layer 3 as described above is disposed on the first coating layer 2. Liquid absorbing filler 4 is shown being dispersed within the second coating layer 3. The printing medium made in accordance with the present invention can be printed with commercially available inks, such as, acid, basic, direct, or reactive dye based inks or pigmented inks, and such inks may utilize either water, organic solvent, or water/organic solvent (co-solvent) systems.

Various methods, tools, or recording devices for forming images, such as by printing, may utilize the printing medium of the present invention. Such tools and recording devices using an ink or recording liquid containing a recording agent, such as a dye or pigment, include, without limitation, fountain pens, ball point pens, felt pens, pen plotters, ink mist, ink jet and a variety of printing devices known in the art. Images are recorded by applying the ink or recording liquid to the second coating layer of the printing medium. By employing a second coating layer comprising a composition which is transparent or translucent, it is possible to view the images from the side at which the ink was applied. As indicated above, it is also possible to view the image through the substrate. Another image formation process using the recording medium of the present invention comprises recording images by applying ink or recording medium droplets to the second coating layer, adhering the second coating layer of the printing medium on which images have been recorded, to a substrate made of metal, plastic, cloth, paper, and the like, followed by application of heat to, or contact bonding of, both of these, to form recorded images on the substrate by using ink.

### EXAMPLES

Various sheets comprising printing media in accordance with the present invention were made employing the compositions described below for the first and second coating layers. These compositions were respectively prepared in a flask equipped with an overhead stirrer. Although not required, the components were added in the order as listed. After introducing the components into the flask, the composition was admixed by stirring for about 30 minutes to provide a substantially uniform mixture or solution. A transparent, 5 mil thick polyester film (produced by SKC America, Inc.) was employed as a substrate. Initially, a transparent sheet was formed by applying a first coating layer composition as described below to the substrate according to a bar coater method utilizing a Bird knife and dried at about 180° F. for about 2 minutes to form a substantially non-porous film having a thickness after drying of about 800 micro inches. Thereafter, a second layer coating solution is applied and dried in the same manner as above to the first coating layer to form the printing medium. After drying, the second layer coating is a porous film having thickness of about 1,200 micro inches. Further coating methods which may be employed in the present invention are described in U.S. Pat. Nos. 5,656,378; 5,723,179; and 5,693,410, all of which are incorporated herein by reference.

Print quality of printed printing media made in accordance with the present invention was evaluated. The respective printing medium sheets were made as described above and employed first and second coating layers having the compositions described below disposed on a transparent, 5 mil thick polyester film (produced by SKC America, Inc.). The test prints were printed with Epson Stylus 7000, Epson Stylus 7500, HP 2000CP, Encad 700e, Encad Pro ink jet printers. The inks employed were Epson 7000 ink, Epson 7500 ink (pigmented), HP IMAGE and UV (pigmented) inks, EnCad 700e GO (pigmented), GS, and GX inks, and EnCad Pro GO (pigmented), GS, and GA inks.

Ink absorbency was evaluated by measuring the drying time at room temperature (25° C., 65% relative humidity) of a printed pattern printed by an ink jet printer. The printed pattern was determined to be sufficiently dry and fixed when an observer was able to touch the printed pattern without receiving an ink stain.

Optical reflective color density of cyan, magenta, yellow, and black (CMYK) was measured on the substrate side with an spectrophotometer manufactured by X-ride Inc., Grandville, Mich., USA under the tradename

Digital Swatchbook

Over all printing quality, including intercolor bleeding, mottle, etc., was visually evaluated by a human observer. “O” designates that the suitability of the printing medium to ink jet recording was good, in that no intercolor bleeding, mottle, and the like were observed on the printed sample and the image quality was excellent. “X” designates that the sample was not suitable for ink jet printing, in that severe intercolor bleeding, severe mottling, and the like were observed in the printed sample and image quality was poor.

The results of this evaluation are reported in Tables 1, 2, and 3 below.

### Example 1

First Coating Layer

40 g LUVISKOL PVP-90, polyvinylpyrrolidone, from BASF Corporation, Mt Olive N.J., USA

10 g CARBOSET 2299 acrylic resin from BF Goodrich Performance Materials, Cleveland, Ohio, USA

8 g sulfosalicylic acid

6 g AMP-95 amine surfactant from Dow Chemical Company, Midland, Mich., USA.

0.25 g SILWET L7200 surfactant from OSI Specialties Inc. Sistersville, W.Va., USA

300 g Methanol

Second Coating Layer

22.5 g Eastman cellulose acetate propionate, 0.5 second, from Eastman Chemical Company, Kingsport, Tenn. 37662, USA

32.1 g SYLOID 161 silica gel (silica particles average diameter˜5 microns, pore volume 1.1 cc/gm) from W. R. Grace Davison & Co.-Conn. Baltimore, UAS

20 g Water

148 g Methyl ethyl ketone

0.15 g SILWET L7200 from OSI Specialties Inc. Sistersville, W.Va., USA

### Example 2

First Coating Layer Same as in Example 1

Second Coating Layer

30 g ESTANE 5715 thermoplastic polyurethane from BF Goodrich Performance Materials, Cleveland, Ohio, USA

26 g SYLOID 161 silica gel (silica particles average diameter˜5 microns, pore volume 1.1 cc/gm) from W. R. Grace Davison & Co.-Conn. Baltimore, Md., USA

17 g SYLOID 620 silica gel (silica particles average diameter˜15 microns, pore volume 1.1 cc/gm) from W. R. Grace Davison & Co.-Conn.

Baltimore, Md., USA

27 g Ethanol

201 g Methyl ethyl ketone

0.15 g SILWET L7200 surfactant from OSI Specialties Inc. Sistersville, W.Va., USA

### Example 3

First Coating Layer

56 g polyvinylpyrrolidone, PVP K-90 from BASF

6 g CARBOSET 2299 Acrylic resin from BF Goodrich Performance Materials, Cleveland, Ohio, USA

12 g Citric acid

8 g AMP 95

0.16 g SILWET L7200 from OSI Specialties Inc. Sistersville, W.Va., USA

0.6 g TINUVIN 1130, UV absorber from Ciba Specialty Chemicals Corporation, Tarrytown, N.Y., USA

0.6 g TINUVIN 292, light stabilizer from Ciba Specialty Chemicals Corporation, Tarrytown, N.Y., USA

400 g Methanol

Second Coating Layer

30 g ESTANE 5715P thermoplastic polyurethane from BF Goodrich Performance Materials, Cleveland, Ohio, USA

45 g SYLIOD 161, silica gel (silica particles average diameter˜5 microns, pore volume 1.1 cc/gm) from W. R. Grace Davison & Co.-Conn. Baltimore, Md.,USA.

200 Methyl ethyl ketone

0.2 g SILWET L7001 from OSI Specialties Inc. Sistersville, W.Va., USA

28 g Methanol

0.5 g TINUVIN 1130 from Ciba Specialty Chemicals Corporation, Tarrytown, N.Y., USA

0.5 g TINUVIN 292 from Ciba Specialty Chemicals Corporation, Tarrytown, N.Y., USA

### Example 4

First Coating Layer

27.6 g AIRVOL 203S, polyvinyl alcohol from Air Products and Chemicals Inc, Allentown Pa. USA

9.3 g AIRVOL 205S, polyvinyl alcohol from Air Products and Chemicals Inc, Allentown Pa. USA

9.3 g LUVISKOL PVP-90, polyvinylpyrrolidone, from BASF Corporation, Mt Olive N.J., USA

2.3 g CORCAT P-600, polyethyleneimine from Sybron Chemicals Inc.

Wellford, S.C., USA.

0.12 g Dow Coming 57 ultraviolet light absorber, from Dow Coming Corp, Midland, Mich., USA.

368 g Water

Second Coating Layer

25.5 g ESTANE 5727, thermoplastic polyurethane from BF Goodrich Performance Materials, Cleveland, Ohio, USA

65 g SYLOID W500, silica (silica particles average diameter 5 microns, pore volume 1.7 cc/gm)from W. R. Grace Davison & Co.-Conn. Baltimore, Md., USA

125 g Methyl ethyl ketone

0.16 g SILWET L7001 from OSI Specialties Inc. Sistersville, W.Va., USA

### Comparative Example 1

First Coating Layer Same as in Example 3

### Comparative Example 1

First Coating Layer Same as in Example 3

Second Coating Layer

30 g ESTANE 5715P, from BF Goodrich Performance Materials, Cleveland, Ohio, USA

45 g ACUMIST C-5, Polyethylene resin, particle size˜6 μm, Honeywell Corporation, Morristown, N.J., UAS

200 Methyl ethyl ketone

0.2 g SILWET L7001 from OSI Specialties Inc. Sistersville, W.Va., USA

28 g Methanol

0.5 g TINUVIN 1130

0.5 g TINUVIN 292

### Comparative Example 2

First Coating Layer Same as Example 3

Second Coating Layer

30 g ACUMIST A-6 Polyethylene resin, particle size˜6 μm, from Honeywell Corporation, Morristown, N.J., UAS

20 g VANCRYL 650, Polyvinyl acetate latex, from Air Products and Chemicals Inc, Allentown, Pa., USA

100 g Water

TABLE 1
Ink Absorbency Test Results-Drying Time

| | | | | |
|---|---|---|---|---|
| Epson | Epson | HP 2000CP | EnCad 700e | EnCad Pro |

| Printer | 7000 | 7500 | image | UV | GO | GS | GX | GO | GS | GA |
|---|---|---|---|---|---|---|---|---|---|---|
| Example | <1 | <1 sec | <1 | <1 | <1 | <1 | <1 | <1 | <1 | <1 |
| 1 | sec | | | | | | | | | |
| Example | <1 | <1 sec | <1 | <1 | <1 | <1 | <1 | <1 | <1 | <1 |
| 1 | sec | | | | | | | | | |
| Example | <1 | <1 sec | <1 | <1 | <1 | <1 | <1 | <1 | <1 | <1 |
| 3 | sec | | | | | | | | | |
| Example | <1 | <1 sec | <1 | <1 | <1 | <1 | <1 | <1 | <1 | <1 |
| 4 | sec | | | | | | | | | |
| Comp 1 | >20 | >20 | >20 | >20 | >20 | >20 | >20 | >20 | >20 | >20 |
| | min. | min. | min. | min. | min. | min. | min. | min. | min. | min. |
| Comp 2 | >20 | >20 | >20 | >20 | >20 | >20 | >20 | >20 | >20 | >20 |
| | min. | min. | min. | min. | min. | min. | min. | min. | min. | min. |

TABLE 2
Average Density of Four Colors (CMYK)

| | | | | |
|---|---|---|---|---|
| Epson | Epson | HP 2000CP | EnCad 700e | EnCad Pro |

| Printer | 7000 | 7500 | image | UV | GO | GS | GX | GO | GS | GA |
|---|---|---|---|---|---|---|---|---|---|---|
| Example 1 | >1 | >1 | >1 | >1 | >1 | >1 | >1 | >1 | >1 | >1 |
| Example 2 | >1 | >1 | >1 | >1 | >1 | >1 | >1 | >1 | >1 | >1 |
| Example 3 | >1 | >1 | >1 | >1 | >1 | >1 | >1 | >1 | >1 | >1 |
| Example 4 | >1 | >1 | >1 | >1 | >1 | >1 | >1 | >1 | >1 | >1 |
| Comp 1 | <0.4 | <0.4 | <0.4 | <0.4 | <0.4 | <0.4 | <0.4 | <0.4 | <0.4 | <0.4 |
| Comp 2 | <0.4 | <0.4. | <0.4 | <0.4 | <0.4 | <0.4 | <0.4 | <0.4 | <0.4 | <0.4 |

3) Image Quality

| | | | | | | | | | | |
|---|---|---|---|---|---|---|---|---|---|---|
| Example 1 | ◯ | ◯ | ◯ | ◯ | ◯ | ◯ | ◯ | ◯ | ◯ | ◯ |
| Example 2 | ◯ | ◯ | ◯ | ◯ | ◯ | ◯ | ◯ | ◯ | ◯ | ◯ |
| Example 3 | ◯ | ◯ | ◯ | ◯ | ◯ | ◯ | ◯ | ◯ | ◯ | ◯ |
| Example 4 | ◯ | ◯ | ◯ | ◯ | ◯ | ◯ | ◯ | ◯ | ◯ | ◯ |
| Comp 1 | X | X | X | X | X | X | X | X | X | X |
| Comp 2 | X | X | X | X | X | X | X | X | X | X |

Although the invention has been described in detail for the purpose of illustration, it is understood that such detail is solely for that purpose, and variations can be made therein by those skilled in the art without departing from the spirit and scope of the invention which is defined by the following claims.

What is claimed is:

1. A printing medium comprising:
a substrate;
a first coating layer disposed on the substrate; and
a second coating layer having a microporous structure disposed on the first coating layer and comprising at least one hydrophobic polymer and at least one liquid absorbing filler dispersed substantially throughout the at least one hydrophobic polymer.

2. The printing medium according to claim 1, wherein the substrate comprises a transparent, translucent, or opaque material.

3. The printing medium according to claim 1, wherein the substrate comprises a rigid or a flexible material.

4. The printing medium according to claim 1, wherein the substrate comprises a polymer, a paper, a glass, a ceramic, or a cloth.

5. The printing medium according to claim 1, wherein the substrate comprises a polymer selected from polyesters, polycarbonates, cellulose esters, polyurethanes, polyester-ethers, polyether-ketones, vinyl polymers, polystyrene, polyethylene terephthalate, polysulfones, polybutylene terephthalate, polypropylene, methacrylates, diallyl phthalates, cellophane, acetates, cellulose diacetate, cellulose triacetate, celluloid, polyvinyl chloride, or combinations thereof.

6. The printing medium according to claim 1, wherein the first coating layer is substantially non-porous.

7. The printing medium according to claim 1, wherein the first coating layer comprises at least one hydrophilic polymer.

8. The printing medium according to claim 7, wherein the at least one hydrophilic polymer is selected from polyvinyl pyrrolidone, polyvinyl alcohol, acrylic polymers, copolymers possessing hydrophilic groups, cellulose polymers, starch, gelatin, albumin, casein, cation starch, gum arabic, sodium alginate, polyamide, polyacrylamide, polyethylene imine, polyvinyl pyridylium halide, melamine resin, polyurethane, polyester, sodium polyacrylate, or a combination thereof.

9. The printing medium according to claim 1, wherein the first coating layer comprises at least one hydrophilic polymer, at least one cationic resin, or a combination thereof.

10. The printing medium according to claim 1, wherein the first coating layer has a thickness in a range between about 3 microns to about 25 microns.

11. The printing medium according to claim 1, wherein the first coating layer has a thickness in a range between about 7 microns to about 15 microns.

12. The printing medium according to claim 1, wherein the at least one hydrophobic polymer is selected from polyethylene, polypropylene, polyurethanes, vinyl acetate, cellulose esters, cellulose acetate propionate, polyvinyl chloride-vinyl acetate copolymer, poly(alkyl)acrylates, ionomer polymers, acrylonitrile-styrene copolymer, ethylene-vinyl acetate copolymer, vinylidene chloride, polyvinyl acetate, styrene-acrylic copolymer, phenolic resins, isobutylene-moleic anhydride copolymer, epoxy resins, polyvinylidene chloride, xylene-formaldehyde resins, cumarone resins, ketone resins, polyvinyl butyral resins, acrylic resins, methyl cellulose, ethyl cellulose, styrene butadiene rubber, polychloroprene resins, melamine formaldehyde resins, nitrile rubber, urea formaldehyde resins, or a combination thereof.

13. The printing medium according to claim 1, wherein the at least one liquid absorbing filler is selected from silica, talc, calcium silicate, aluminum silicate, titanium silicate, clays, titanium dioxide, or alumina.

14. The printing medium according to claim 1, wherein the at least one liquid absorbing filler comprises porous particles.

15. The printing medium according to claim 1, wherein the at least one liquid absorbing filler comprises porous particles selected from inorganic particles, polymeric particles, or a combination thereof.

16. The printing medium according to claim 1, wherein the at least one liquid absorbing filler comprises porous polymeric particles selected from polyethylene, polypropylene, polyurethane, vinyl acetate, cellulose esters, cellulose acetate propionate, polyvinyl chloride-vinyl acetate copolymer, poly(alkyl)acrylates, ionomer polymers, acrylonitrile-styrene copolymer, ethylene-vinyl acetate copolymer, vinylidene chloride, polyvinyl acetate, styrene-acrylic copolymer, phenolic resins, isobutylene-moleic anhydride copolymer, epoxy resins, polyvinylidene chloride, xylene-formaldehyde resins, cumarone resins, ketone resins, polyvinyl alcohol, polyvinyl butyral resins, polyvinyl pyrrolidone, acrylic resins, starch, carboxymethyl cellulose, methyl cellulose, ethyl cellulose, styrene butadiene rubber, gelatin, casein, polychloroprene resins, melamine formaldehyde resins, nitrile rubber, urea formaldehyde resins, or a combination thereof.

17. The printing medium according to claim 1, wherein the at least one liquid absorbing filler comprises particles having an average diameter between about 2 nanometers to about 50 microns.

18. The printing medium according to claim 1, wherein the at least one liquid absorbing filler comprises particles having an average diameter between about 2 microns to about 25 microns.

19. The printing medium according to claim 1, wherein the second coating layer has a thickness in a range between about 5 microns to about 50 microns.

20. The printing medium according to claim 1, wherein the second coating layer has a thickness in a range between about 15 microns to about 35 microns.

21. The printing medium according to claim 1, wherein the weight ratio of the at least one liquid absorbing filler to the at least one hydrophobic polymer ranges between about 0.3 to about 15.

22. The printing medium according to claim 1, wherein the weight ratio of the at least one liquid absorbing filler to the at least one hydrophobic polymer ranges between about 0.6 to about 10.

23. The printing medium according to claim 1, wherein the printing medium is in the form of a film or sheet.

24. A printing medium comprising an ink retaining first coating layer and an ink transmissive second coating layer comprising at least one hydrophobic polymer and at least one liquid absorbing filler respectively disposed on a substrate.

25. The printing medium according to claim 24, wherein the first coating layer is substantially non-porous.

26. The printing medium according to claim 24, wherein the second coating layer is porous.

27. The printing medium according to claim 24, wherein the substrate comprises a transparent, translucent, or opaque material.

28. The printing medium according to claim 24, wherein the substrate comprises a rigid or a flexible material.

29. The printing medium according to claim 24, wherein the substrate comprises a polymer, a paper, a glass, a ceramic, or a cloth.

30. The printing medium according to claim 24, wherein the substrate comprises a polymer selected from polyesters, polycarbonates, cellulose esters, polyurethanes, polyester-ethers, polyether-ketones, vinyl polymers, polystyrene, polyethylene terephthalate, polysulfones, polybutylene terephthalate, polypropylene, methacrylates, diallyl phthalates, cellophane, acetates, cellulose diacetate, cellulose triacetate, celluloid, polyvinyl chloride, or combinations thereof.

31. The printing medium according to claim 24, wherein the first coating layer comprises at least one hydrophilic polymer.

32. The printing medium according to claim 31, wherein the at least one hydrophilic polymer is selected from polyvinyl pyrrolidone, polyvinyl alcohol, acrylic polymers, copolymers possessing hydrophilic groups, cellulose polymers, starch, gelatin, albumin, casein, cation starch, gum arabic, sodium alginate, polyamide, polyacrylamide, polyethylene imine, polyvinyl pyridylium halide, melamine resin, polyurethane, polyester, sodium polyacrylate, or a combination thereof.

33. The printing medium according to claim 24, wherein the first coating layer comprises at least one hydrophilic polymer, at least one cationic resin, or a combination thereof.

34. The printing medium according to claim 24, wherein the first coating layer has a thickness in a range between about 3 microns to about 25 microns.

35. The printing medium according to claim 24, wherein the first coating layer has a thickness in a range between about 7 microns to about 15 microns.

36. The printing medium according to claim 24, wherein the at least one hydrophobic polymer is selected from polyethylene, polypropylene, polyurethanes, vinyl acetate, cellulose esters, cellulose acetate propionate, polyvinyl chloride-vinyl acetate copolymer, poly(alkyl)acrylates, ionomer polymers, acrylonitrile-styrene copolymer, ethylene-vinyl acetate copolymer, vinylidene chloride, polyvinyl acetate, styrene-acrylic copolymer, phenolic resins, isobutylene-moleic anhydride copolymer, epoxy resins, polyvinylidene chloride, xylene-formaldehyde resins, cumarone resins, ketone resins, polyvinyl butyral resins, acrylic resins, methyl cellulose, ethyl cellulose, styrene butadiene rubber, polychloroprene resins, melamine formaldehyde resins, nitrile rubber, urea formaldehyde resins, or a combination thereof.

37. The printing medium according to claim 24, wherein the at least one liquid absorbing filler is selected from silica, talc, calcium silicate, aluminum silicate, titanium silicate, clays, titanium dioxide, alumina, or a combination thereof.

38. The printing medium according to claim 24, wherein the at least one liquid absorbing filler comprises porous particles.

39. The printing medium according to claim 24, wherein the at least one liquid absorbing filler comprises porous particles selected from inorganic particles, polymeric particles, or a combination thereof.

40. The printing medium according to claim 24, wherein the at least one liquid absorbing filler comprises porous polymeric particles selected from polyethylene, polypropylene, polyurethane, vinyl acetate, cellulose esters, cellulose acetate propionate, polyvinyl chloride-vinyl acetate copolymer, poly(alkyl)acrylates, ionomer polymers, acrylonitrile-styrene copolymer, ethylene-vinyl acetate copolymer, vinylidene chloride, polyvinyl acetate, styrene-acrylic copolymer, phenolic resins, isobutylene-moleic anhydride copolymer, epoxy resins, polyvinylidene chloride, xylene-formaldehyde resins, cumarone resins, ketone resins, polyvinyl alcohol, polyvinyl butyral resins, polyvinyl pyrrolidone, acrylic resins, starch, carboxymethyl cellulose, methyl cellulose, ethyl cellulose, styrene butadiene rubber, gelatin, casein, polychloroprene resins, melamine formaldehyde resins, nitrile rubber, urea formaldehyde resins, or a combination thereof.

41. The printing medium according to claim 24, wherein the at least one liquid absorbing filler comprises particles having an average diameter between about 2 nanometers to about 50 microns.

42. The printing medium according to claim 24, wherein the at least one liquid absorbing filler comprises particles having an average diameter between about 2 microns to about 25 microns.

43. The printing medium according to claim 24, wherein the second coating layer has a thickness in a range between about 5 microns to about 50 microns.

44. The printing medium according to claim 24, wherein the second coating layer has a thickness in a range between about 15 microns to about 35 microns.

45. The printing medium according to claim 24, wherein the weight ratio of the at least one liquid absorbing filler to the at least one hydrophobic polymer ranges between about 0.3 to about 15.

46. The printing medium according to claim 24, wherein the weight ratio of the at least one liquid absorbing filler to the at least one hydrophobic polymer ranges between about 0.6 to about 10.

47. The printing medium according to claim 24, wherein the printing medium is in the form of a film or sheet.

48. A printing medium comprising:
a substrate comprised of an organic transparent or translucent material,
a first coating layer upon said substrate, the first coating layer comprised of at least one hydrophilic polymer, and
a second coating layer upon said first coating layer, the second coating layer comprised of a microporous structure formed by the combination of at least one liquid absorbing, inorganic filler incorporated into at least one organic, hydrophobic polymer.

49. A process for forming an image comprising applying an ink onto a recording medium as claimed in claim 1.

50. A process for forming an image comprising applying an ink onto a recording medium as claimed in claim 24.

51. A process for forming an image comprising applying an ink onto a recording medium as claimed in claim 48.
